(19) United States
(12) Patent Application Publication
(10) Pub. No.: US 2016/0134179 A1
(43) Pub. Date: May 12, 2016

(54) METHOD OF MANUFACTURING ROTOR

(71) Applicant: MITSUI HIGH-TEC, INC., Kitayushu-shi (JP)

(72) Inventors: Akira NAGAI, Fukuoka (JP); Kohei YOSHIDA, Fukuoka (JP)

(73) Assignee: MITSUI HIGH-TEC , INC., Kitakyushu-shi (JP)

(21) Appl. No.: 14/926,625

(22) Filed: Oct. 29, 2015

(30) Foreign Application Priority Data
Nov. 6, 2014 (JP) 2014-226201

(51) Int. Cl. H02K 15/03

(52) U.S. Cl. CPC H02K 15/03

(57) ABSTRACT

There is provided a method of manufacturing a rotor that includes a permanent magnet inserted into a magnet-insert hole formed in a rotor core, a positioning member which is inserted into the magnet-insert hole and positions the permanent magnet with respect to the rotor core, and a resin material for fixing the permanent magnet to the magnet-insert hole by filling the magnet-insert hole with the resin material. In the method, a mold unit is provided above or below the rotor core, and another positioning member used for manufacturing another rotor is molded using the mold unit while filling the magnet-insert hole with the resin material.

### CROSS REFERENCE TO RELATED APPLICATION(S)

This application is based upon and claims the benefit of priority of Japanese Patent Application No. 2014-226201 filed on Nov. 6, 2014, the contents of which are incorporated herein by reference in its entirety.

### BACKGROUND OF THE INVENTION

1. Field of the Invention

The present invention relates to a method of manufacturing a rotor including a permanent magnet, and particularly to the method of manufacturing the rotor in which the permanent magnet is inserted into a magnet-insert hole formed in a rotor core and the permanent magnet is fixed to the rotor core.

2. Description of the Related Art

In a manufacturing method of a rotor including a permanent magnet, it is known that the permanent magnet is inserted into a magnet-insert hole formed in a rotor core and the permanent magnet is fixed to the rotor core. For example, Japanese Patent No. 4414417 as Patent Reference 1 discloses that a permanent magnet is inserted into each magnet-insert hole of a rotor core (iron core body) having plural magnet-insert holes (magnet-insert parts) and then a liquid resin material is pressurized and injected into each of the magnet-insert holes and then the resin material is cured and the permanent magnet is fixed.

Also, an applicant et al. of the present application filed a related Japanese patent application No. 2014-215034 of a manufacturing method of a rotor characterized by having a positioning member coupling step of inserting a positioning member into a magnet-insert hole from one end of a rotor core and coupling the positioning member to the rotor core, a permanent magnet coupling step of inserting a permanent magnet into the magnet-insert hole from the other end of the rotor core and fitting the permanent magnet into the previously fixed positioning member and coupling the permanent magnet to the rotor core, and a filling and curing step of injecting a resin material into the magnet-insert hole and filling a gap between the magnet-insert hole and the permanent magnet with the resin material and then curing the resin material.

Patent Reference 1: Japanese Patent No. 4414417

### SUMMARY OF THE INVENTION

According to Patent Reference 1, a part of the resin material injected into the magnet-insert hole from a resin pool part remains in a resin flow path ranging from the resin pool part to the magnet-insert hole, and is cured inside the resin flow path. The resin material cured inside the resin flow path in this manner is called a “surplus resin”, and is removed and discarded (Patent Reference 1, Paragraph 0028, FIG. 1). As a result, the manufacturing method described in Patent Reference 1 has a problem of running up a material cost since a yield of the resin material is low, and also has a problem of producing a discard cost of the surplus resin.

Also, the method in the Japanese patent application No. 2014-215034 needs to previously manufacture the positioning member, and needs to separately prepare a mold unit for the manufacture of the positioning member. As a result, there is a problem of increasing an equipment cost of the manufacture of the positioning member. Also, there is a problem of running up the material cost and the discard cost like the manufacturing method described in Patent Reference 1 since the surplus resin is formed also in a step of manufacturing (molding) the positioning member.

The present invention has been implemented in view of such circumstances, and a non-limited object of one or more of embodiments of the present invention is to improve a yield of a resin material and reduce a material cost and also reduce a discard cost of a surplus resin.

There is provided a method of manufacturing a rotor that includes a permanent magnet inserted into a magnet-insert hole formed in a rotor core, a positioning member which is inserted into the magnet-insert hole and positions the permanent magnet with respect to the rotor core, and a resin material for fixing the permanent magnet to the magnet-insert hole by filling the magnet-insert hole with the resin material, the method including: providing a mold unit above or below the rotor core; and molding another positioning member used for manufacturing another rotor using the mold unit while filling the magnet-insert hole with the resin material.

The rotor core may be held between an upper mold unit and a lower mold unit, and the rotor core may be mounted on a resin filling apparatus in which a resin flow path for injecting the resin material into the magnet-insert hole is formed between the rotor core and the upper mold unit or the lower mold unit, and the magnet-insert hole is filled with the resin material.

The mold unit may be formed in a middle of the resin flow path.

The mold unit may be formed in a distal part of a branch path branched from the resin flow path.

The mold unit may be formed in a further distal part of the magnet-insert hole and the resin material is injected into the mold unit through the magnet-insert hole.

The motor core may be placed on a jig and is mounted on the resin filling apparatus, and the jig may be held between the lower mold unit and the rotor core.

A dummy plate abutting on the rotor core above or below the rotor core may be mounted on the rotor core, and the rotor core may be mounted on the resin filling apparatus.

The mold unit may include a recess and a protrusion formed in any of the upper mold unit, the lower mold unit, the dummy plate and the jig, or combination of recesses and protrusions formed in the upper mold unit, the lower mold unit, the dummy plate and the jig.

There is also provided a method of manufacturing a rotor, including: inserting a permanent magnet into a magnet-insert hole formed in a rotor core for the rotor; inserting a positioning member into the magnet-insert hole to position the permanent magnet with respect to the rotor core; providing a mold unit above or below the rotor core; molding another positioning member used for manufacturing another rotor using the mold unit while filling the magnet-insert hole with a resin material; and curing the resin material to fix the permanent magnet to the magnet-insert hole.

According to one or more aspects of the present invention, a part of a surplus resin is reused as the positioning member, with the result that a yield of the resin material is improved and a material cost can be reduced. Also, a discard cost of the surplus resin can be reduced. Further, since another positioning member is simultaneously molded in a filling and curing step, it is unnecessary to separately include a step of molding such positioning member. As a result, an equipment cost and a running cost are reduced.

### BRIEF DESCRIPTION OF THE DRAWINGS

In the accompanying drawings:

FIG. 1 is a plan sectional view in which an electric motor including a rotor according to an embodiment of the invention is cut by a plane perpendicular to a rotating shaft;

FIG. 2 is a schematic longitudinal sectional view in which the rotor is cut by a plane including the rotating shaft;

FIG. 3 is a perspective view showing an external shape of a positioning member attached to the rotor;

FIGS. 4A and 4B are explanatory diagrams showing a configuration of an apparatus for filling the rotor with a resin material, in which FIG. 4A is a longitudinal sectional view of a main part of the apparatus, and FIG. 4B is a perspective view showing an external shape of a mold unit;

FIGS. 5A to 5E are longitudinal sectional views of a main part of an apparatus for filling the rotor with the resin material, showing configuration of modified examples of the apparatus;

FIGS. 6A to 6E are perspective views showing modified examples of the positioning member;

FIG. 7 is a perspective view showing a state in which permanent magnets are attached to the positioning member;

FIGS. 8A and 8B are perspective views showing modified examples of the positioning member; and

FIGS. 9A to 9C are longitudinal sectional views of a main part of an apparatus for filling the rotor with the resin material, showing configurations of modified examples of the apparatus.

### DETAILED DESCRIPTION OF THE EXEMPLARY EMBODIMENTS

A manufacturing method of a rotor according to an embodiment of the present invention will hereinafter be described in detail with reference to the accompanying drawings.

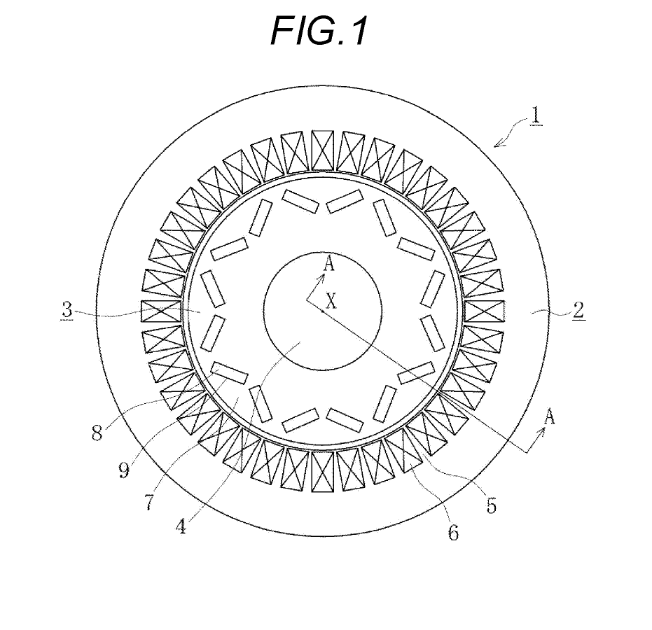

FIG. 1 is a plan sectional view of an electric motor 1 including the rotor according to the embodiment of the invention. As shown in FIG. 1, the electric motor 1 includes a stator 2 and a rotor 3. The stator 2 includes a plurality of teeth 5, and a winding 6 is wound on each of the teeth 5. The rotor 3 is rotatably supported in a bracket (not shown) through a rotating shaft 4, and is freely rotated around the center X of rotation. Also, the rotor 3 includes a rotor core 7 and plural permanent magnets 8. The rotor core 7 is formed with a plurality of magnet-insert holes 9, and the permanent magnets 8 are inserted into the respective magnet-insert holes 9.

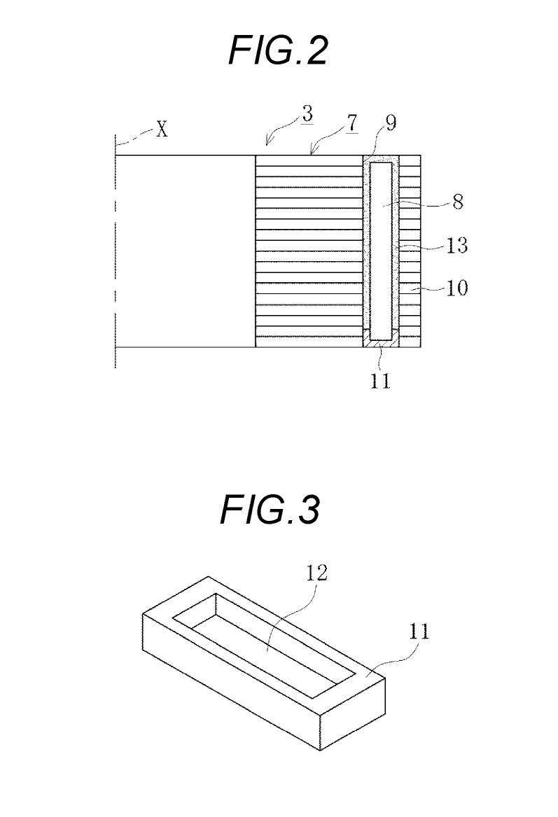

FIG. 2 schematically shows a cross section in which the rotor 3 is cut by a plane including the center X of rotation of the rotating shaft 4, that is, the cross section cut on line A-A of FIG. 1. As shown in FIG. 2, the rotor core 7 is constructed by laminating a plurality of iron core pieces 10. In addition, each of the iron core pieces 10 is blanked, and is formed with a through hole having the same shape. In a state shown in FIG. 2, the iron core pieces 10 are laminated with the through holes aligned in the same position. As a result, the rotor core 7 is formed with the magnet-insert hole 9. The magnet-insert hole 9 is formed through the rotor core 7 in a vertical direction. In the lower end of the magnet-insert hole 9, a positioning member 11 is arranged so that a lower surface of the positioning member 11 has the same height as a lower surface of the rotor core 7, and is fitted into the magnet-insert hole 9. The permanent magnet 8 is inserted into the magnet-insert hole 9 from an upper surface of the rotor core 7, and is fitted into the positioning member 11 in the lower end of the magnet-insert hole 9. Also, a gap between the magnet-insert hole 9 and the permanent magnet 8 is filled with a resin material 13, and the permanent magnet 8 is fixed in the magnet-insert hole 9. In addition, a kind of resin material 13 is not particularly limited. An optimum resin can be selected according to a use condition or use of the electric motor 1. Here, an epoxy thermosetting resin is used.

Since a plane external shape of the positioning member 11 is formed in substantially the same shape as a cross-sectional shape (shape represented in FIG. 1) of the magnet-insert hole 9 as shown in FIG. 3, when the positioning member 11 is fitted into the magnet-insert hole 9, the positioning member 11 is positioned in a predetermined position in a horizontal direction with respect to the rotor core 7. Also, the positioning member 11 is designed to be correctly positioned in a height direction when the lower surface of the positioning member 11 is aligned with the same height as the lower surface of the rotor core 7. An upper surface of the positioning member 11 is formed with a recessed part 12. The recessed part 12 has dimensions of a shape in which the permanent magnet 8 is fitted, and the permanent magnet 8 is designed to be correctly positioned with respect to the positioning member 11 in the horizontal direction and the height direction when the permanent magnet 8 is inserted into the recessed part 12 and is pushed until the distal end of the permanent magnet 8 abuts on a bottom surface of the recessed part 12.

Consequently, when the positioning member 11 is inserted into the magnet-insert hole 9 from the lower surface of the rotor core 7 and the lower surface of the positioning member 11 is aligned with the same height as the lower surface of the rotor core 7 and the permanent magnet 8 is inserted into the magnet-insert hole 9 from the upper surface of the rotor core 7 and is inserted into the recessed part 12 of the positioning member 11 in the lower end of the magnet-insert hole 9 and the distal end of the permanent magnet 8 is brought into contact with the bottom surface of the recessed part 12, the permanent magnet 8 is correctly positioned with respect to the rotor core 7.

The rotor 3 is generally manufactured by the following procedure. First, an electromagnetic steel plate is blanked to manufacture the iron core piece 10. At this time, the magnet-insert hole 9 is also formed. Then, the plural iron core pieces 10 are laminated to form the rotor core 7. The iron core pieces 10 are mutually bonded, and its bonding method is not limited. For example, caulking with a “dowel” may be used, or bonding by welding or adhesion may be used. After the rotor core 7 is formed, the positioning member 11 is inserted into the magnet-insert hole 9 from one surface of the rotor core 7. At this time, the rotor core 7 and the positioning member 11 are pressed on a platen etc., and a bottom surface of the positioning member 11 is aligned with the same height as the one surface of the rotor core 7. Thereafter, the permanent magnet 8 is inserted into the magnet-insert hole 9 from the other surface of the rotor core 7, and the permanent magnet 8 is inserted into the recessed part 12 until the distal end of the permanent magnet 8 abuts on the bottom surface of the recessed part 12 of the positioning member 11.

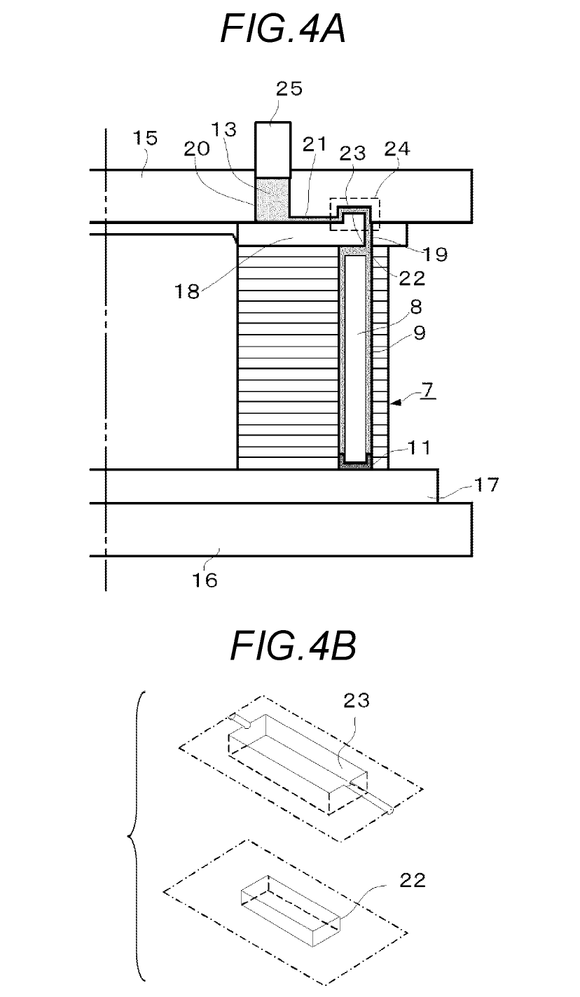

After all of the positioning members 11 and the permanent magnets 8 are assembled to the rotor core 7 by the procedure described above, the magnet-insert holes 9 are filled with the resin materials 13, and the resin materials 13 are cured, and the permanent magnets 8 are fixed to the rotor core 7. The filling with the resin materials 13 is performed by pressing the rotor core 7 with the rotor core 7 held by mold units, that is, an upper mold unit 15 and a lower mold unit 16 using a device as shown in FIG. 4A. In addition, since a resin filling apparatus including the device for pressing the rotor core 7 is publicly known, its detailed description of the mechanism is omitted. When necessary, for example, see JP-A-2014-7899, JP-A-2014-96942, etc.

Now, as shown in FIG. 4A, a jig 17 is arranged between the rotor core 7 and the lower mold unit 16, and a dummy plate 18 is held between the upper mold unit 15 and the rotor core 7. The jig 17 is a kind of conveyance tray for conveying the rotor core 7. The dummy plate 18 is a cover with which an upper surface of the rotor core 7 is covered, and is also called a “cull plate”. Also, a region overlapping with the magnet-insert hole 9 of the rotor core 7 in the case of viewing the dummy plate 18 in plan view is formed with a resin injection hole 19 through the dummy plate 18. In addition, an upper surface (surface abutting on the rotor core 7) of the jig 17, an upper surface and a lower surface of the dummy plate 18 are coated with a coating material (for example, a silicon mold release agent) for preventing adhesion of the resin material 13.

In the upper mold unit 15, a resin pool pod 20 is arranged in correspondence with each of the magnet-insert holes 9 of the rotor core 7. That is, the upper mold unit 15 is formed with the resin pool pods 20 having the same number as the number of magnet-insert holes 9 of the rotor core 7, and each of the resin pool pods 20 is arranged in a position corresponding to each of the magnet-insert holes 9. Also, the upper mold unit 15 is formed with a resin injection groove 21 for communicating the resin pool pod 20 to the resin injection hole 19. As described above, the resin injection hole 19 communicates with the magnet-insert hole 9 of the rotor core 7 through the dummy plate 18. As a result, the resin injection groove 21 and the resin injection hole 19 function as a resin flow path for guiding the liquid resin material 13 delivered from the resin pool pod 20 to the magnet-insert hole 9.

Also, the dummy plate 18 is formed with a protrusion 22, and the resin injection groove 21 is formed with a recess 23, respectively. The protrusion 22 and the recess 23 have shapes as shown in FIG. 4B, and are designed to function as a mold unit 24 for molding the positioning member 11 when the protrusion 22 is aligned with the recess 23. That is, the mold unit 24 is a mold unit for molding the positioning member 11, and is the mold unit arranged in the middle of the resin flow path.

The filling with the resin material 13 is performed by injecting the liquid resin material 13 into the resin pool pod 20. After the liquid resin material 13 is injected into the resin pool pod 20, the liquid resin material 13 is pressurized by a plunger 25 which is driven by a cylinder (not shown) and is upwardly and downwardly moved inside the resin pool pod 20. The pressurized liquid resin material 13 passes through the resin injection groove 21 and the resin injection hole 19 (that is, the resin flow path), and flows into the magnet-insert hole 9. In addition, at this time, air present in the magnet-insert hole 9 is relieved to the outside through a gap between the laminated iron core pieces 10. Then, after the resin material 13 extends to the inside of the magnet-insert hole 9, the rotor core 7 is warmed and the resin material 13 is cured. After the resin material 13 is cured, the rotor core 7, the jig 17 and the dummy plate 18 are taken out of the portion between the upper mold unit 15 and the lower mold unit 16, and the dummy plate 18 is detached from the rotor core 7. At this time, a surplus resin cured inside the resin flow path is also separated from the rotor core 7. Then, when a part present inside the mold unit 24 in this surplus resin is taken out and necessary processing, for example, cutting of a gate is performed, a new positioning member 11 can be obtained. The new positioning member 11 can be used by being attached to the magnet-insert hole 9 in the case of manufacturing the next rotor 3. That is, a part of the surplus resin can be reused as the positioning member 11.

Since the positioning member 11 taken out of the surplus resin has an “affinity” for the resin material 13, the resin material 13 acts as a kind of “adhesive” to the positioning member 11. Also, since a thermal expansion coefficient of the positioning member 11 is equal to that of the resin material 13, there is no difference in expansion and contraction by a change in temperature. As a result, peeling of the positioning member from the resin material resulting from the change in temperature during manufacture or use is not caused. As a result, the positioning member 11 is tightly fixed to the rotor core 7.

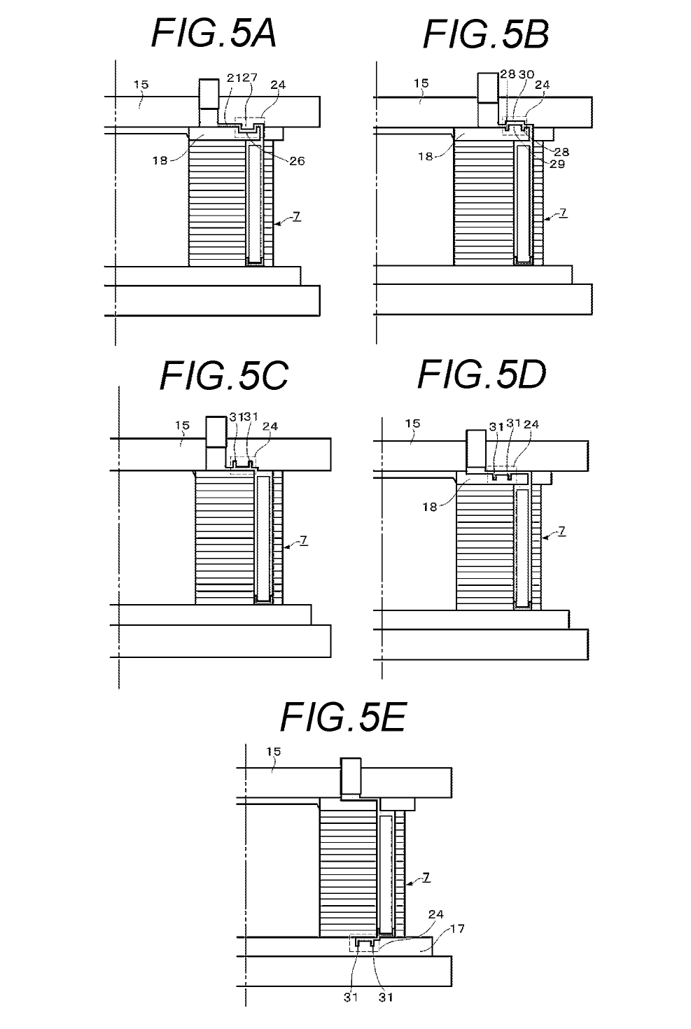

The shape of the mold unit 24 is not limited to the shape shown in FIG. 4B. As shown in FIG. 5A, the mold unit 24 may be constructed by combining a recess 26 formed in the dummy plate 18 with a protrusion 27 formed in the upper mold unit 15, respectively. Alternatively, as shown in FIG. 5B, the mold unit 24 may be constructed by combining recesses 28 and a protrusion 29 formed in the dummy plate 18 with a recess 30 formed in the upper mold unit 15, respectively. Also, as shown in FIG. 5C, the mold unit 24 may be constructed by omitting the dummy plate 18 and forming recesses 31 in the upper mold unit 15. As shown in FIG. 5D, the mold unit 24 may be constructed by forming recesses 31 in the dummy plate 18 without forming the recesses 31 in the upper mold unit 15.

Also, as shown in FIG. 5E, the mold unit 24 may be constructed by forming recesses 31 in the jig 17. By selecting this construction, the positioning member 11 can be molded even when the dummy plate 18 has no space to form the mold unit. Alternatively, the mold unit 24 may be constructed by arranging a dummy plate between the rotor core 7 and the jig 17 and forming recesses 31 in the dummy plate. When the mold unit 24 is formed in the dummy plate, it becomes easier to do work of detaching the positioning member 11 from the mold unit 24 than the case of forming the mold unit 24 in the jig 17.

In addition, in this case, it is necessary to cause a resin to flow through the mold unit 24 formed in the jig 17 or the dummy plate 18 by forming a gap between the positioning member 11 and the magnet-insert hole 9, and the positioning member 11 for forming the gap will be described below.

Alternatively, the construction shown in FIG. 5A or FIG. 5D may be combined with the construction shown in FIG. 5E. That is, the two positioning members 11 may be molded in one filling and curing step by forming the mold units 24 in upper and lower parts of the rotor core 7.

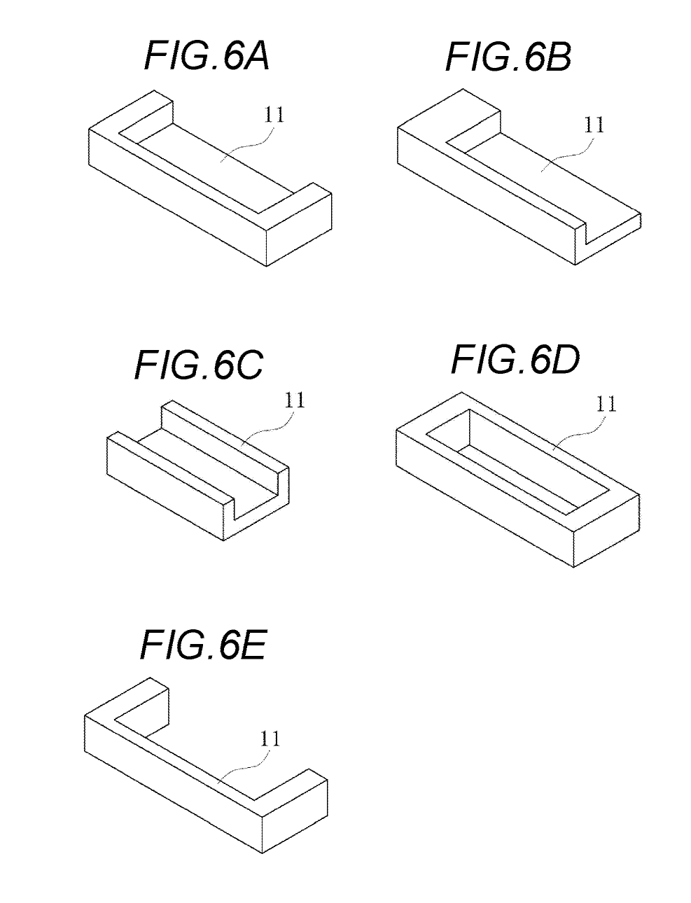

Also, the shape of the positioning member 11 is not limited to the shape shown in FIG. 3. For example, in the case of providing an offset for the permanent magnet 8 in the inside or the outside of the magnet-insert hole 9, the positioning member 11 as shown in FIG. 6A could be used. Also, in the case of providing an offset for the permanent magnet 8 in a longitudinal direction of a plan cross-sectional shape (that is, a cross-sectional shape represented in FIG. 1) of the permanent magnet 8 in addition to the offset in the inside or outside direction, the positioning member 11 as shown in FIG. 6B could be used. Also, the shape and dimensions of the positioning member 11 have only to include the shape and dimensions fitted into the magnet-insert hole 9, and it is unnecessary to include the shape and dimensions covering the whole magnet-insert hole 9. Consequently, the positioning member 11 could be shorter than the length of the magnet-insert hole 9 in a longitudinal direction of a plan cross-sectional shape (that is, a cross-sectional shape represented in FIG. 1) as shown in, for example, FIG. 6C. When this positioning member 11 is fitted into the magnet-insert hole 9, a gap is formed between the positioning member 11 and the magnet-insert hole 9, with the result that it is suitable in the case of constructing the mold unit 24 by forming the recesses in the jig 17 as shown in FIG. 5E. In addition, in the case of using the positioning member 11 shown in FIG. 6C, the magnet-insert hole 9 could include a shape (for example, a projection or a step) in which movement of the positioning member 11 in the longitudinal direction of the magnet-insert hole 9 is restricted.

The positioning member 11 may have a shape without a bottom part. That is, the positioning member 11 may have a shape in which only a frame is had and the center is penetrated vertically as shown in FIG. 6D or 6E. When such a shape is selected, a situation of fitting of the permanent magnet 8 into the positioning member 11 can be visually identified from the outside of the rotor core 7. Also, the positioning member 11 can be previously inserted and fitted into the magnet-insert hole 9 to insert the permanent magnet 8 through an opening of the center of the positioning member 11.

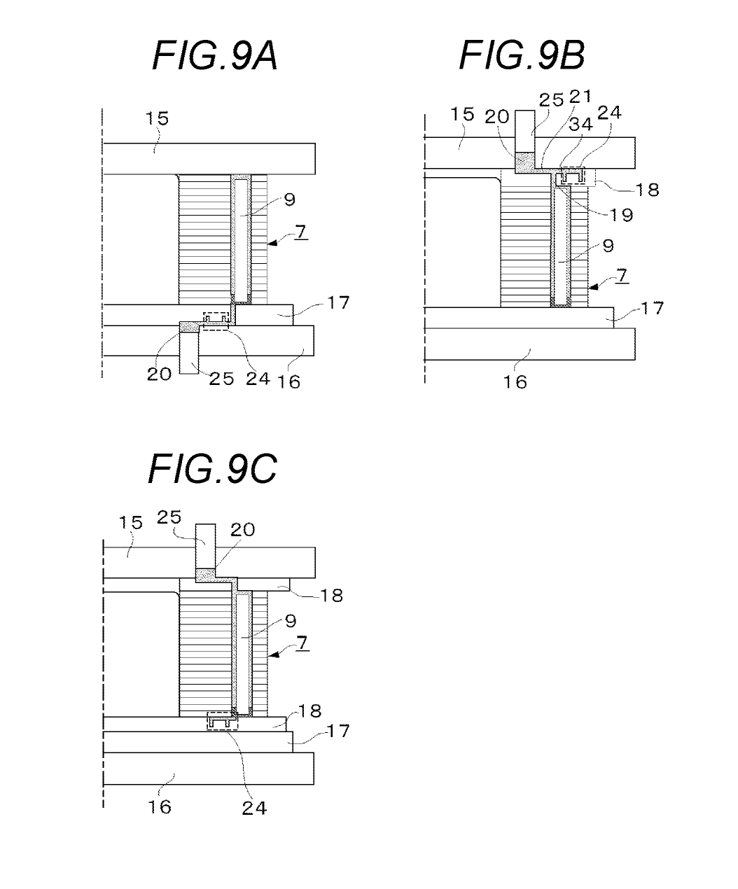

Now, the example in which the resin pool pod 20 is included in the upper mold unit 15 and the plunger 25 is attached to the resin pool pod 20 and the resin material 13 is injected into the magnet-insert hole 9 of the rotor core 7 is shown above. That is, the example in which the resin material 13 is injected from the upper mold unit 15 is shown, but the resin material 13 may be injected from the lower mold unit 16. For example, as shown in FIG. 9A, it may be constructed so that the resin pool pod 20 is included in the lower mold unit 16 and the plunger 25 is attached to the resin pool pod 20 and also the mold unit 24 is included in the jig 17.

Also, the example in which the mold unit 24 is included in the middle of the resin injection hole 19 or the resin injection groove 21, that is, the middle of the resin flow path is shown above, but the mold unit 24 may be formed in a distal part of a branch path branched from the resin flow path. For example, as shown in FIG. 9B, it may be constructed so that a branch path 34 is branched at the boundary between the resin injection groove 21 and the resin injection hole 19 and the mold unit 24 is included in the distal part of the branch path 34.

Alternatively, it may be constructed so that when viewed from the resin pool pod 20, the mold unit 24 is included in a distal part of the magnet-insert hole 9 and the resin material 13 is injected into the mold unit 24 through the magnet-insert hole 9. For example, as shown in FIG. 9C, it may be constructed so that the mold unit 24 is included in the dummy plate 18 arranged under the rotor core 7, that is, the dummy plate 18 arranged between the rotor core 7 and the jig 17 when the resin pool pod 20 is included in the upper mold unit 15 and the plunger 25 is attached to the resin pool pod 20 and the resin material 13 is injected into the magnet-insert hole 9 of the rotor core 7 from the upper mold unit 15. In addition, since the dummy plate 18 is lighter than the jig 17, workability in the case of including the mold unit 24 in the dummy plate 18 is better than that in the case (for example, the case shown in FIG. 9A) of including the mold unit 24 in the jig 17.

In addition, the embodiment described above illustrates the concrete aspects of the present invention, but does not define the technical scope of the present invention. In the present invention, modifications, applications or improvements can be made freely within the scope of the technical idea described in the claims.

In the present invention, “fitting” is not limited to a “state fitted in a state with no looseness or gap”. The “fitting” may be construed in a broader sense. Such a state also corresponds to the “fitting” since a non-limited object of the present invention is achieved even in the case of having some looseness or play within positioning accuracy necessary for the permanent magnet.

Also, in FIGS. 2, 4A, 4B and 5A to 5E, the example in which the positioning member 11 is inserted into the magnet-insert hole 9 from a lower surface of the rotor core 7 and the permanent magnet 8 is inserted into the magnet-insert hole 9 from an upper surface of the rotor core 7 is shown, but an example opposite to its example may be adopted. That is, it may be constructed so that the positioning member 11 is inserted from the upper surface of the rotor core 7 and the permanent magnet 8 is inserted from the lower surface of the rotor core 7. Also, in the embodiment described above, the example in which the resin material 13 is pressurized and injected from the upper surface of the rotor core 7 is shown, but the resin material 13 may be pressurized and injected from the lower surface of the rotor core 7. That is, it may be constructed so that, for example, the resin pool pod 20 is arranged in the lower mold unit 16 and the resin material 13 is pressurized and injected. In this case, the need for the jig 17 is eliminated since the dummy plate 18 can function as a conveyance tray. Alternatively, the dummy plate 18 can be omitted by designing the jig 17 to function as the dummy plate 18. In brief, when the resin material 13 is pressurized and injected from the lower surface of the rotor core 7, it can be designed to use both of the jig 17 and the dummy plate 18 by one member.

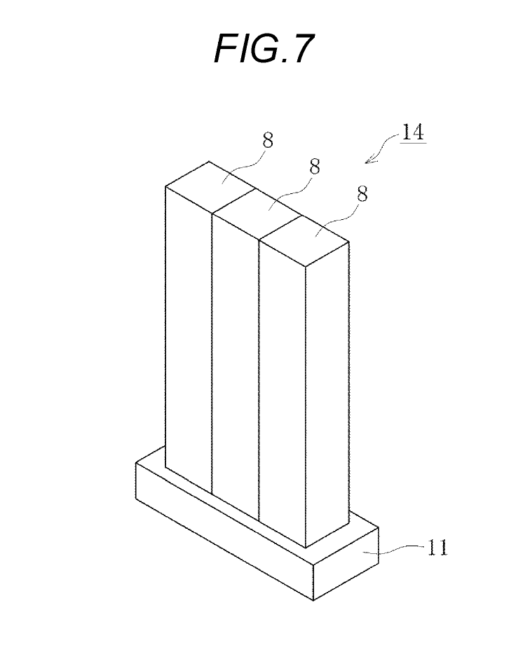

The example in which the permanent magnet 8 and the positioning member 11 are mutually fitted inside the magnet-insert hole 9 is shown above, but it may be constructed so that the permanent magnet 8 and the positioning member 11 are mutually fitted and a set 14 of the permanent magnets 8 and the positioning member 11 as shown in FIG. 7 is formed and the set 14 is inserted into the magnet-insert hole 9 and the positioning member 11 is fitted into the magnet-insert hole 9. Also, the number of permanent magnets 8 fitted into the one positioning member 11 is not limited to one. As shown in FIG. 7, the plural permanent magnets 8 may be fitted into the one positioning member 11.

Also, in the embodiment described above, the example in which the resin material 13 is injected from the surface (the upper surface of the rotor core 7 in FIGS. 4A, 4B and 5A to 5E) opposite to the surface to which the positioning member 11 of the rotor core 7 is attached is shown, but the present invention is not limited to this example. The resin material 13 can be also injected from the surface to which the positioning member 11 of the rotor core 7 is attached. That is, the resin material 13 can be also injected from the lower surface of the rotor core 7 in the device described in FIGS. 4A, 4B and 5A to 5E. In this case, for example, using the positioning member 11 as shown in FIG. 6C, the resin material 13 could be pressurized and injected from a gap formed between the positioning member 11 and the magnet-insert hole 9.

In addition, in the present specification, the “upper surface” and the “lower surface” are representation based on an upper and lower relation in the case of arranging the rotor core 7 in the state shown in FIGS. 2, 4A, 4B and 5A to 5E, and do not indicate an absolute upper and lower relation. That is, when the rotor core 7 is reversed, the “upper surface” and the “lower surface” are replaced, and when the rotor core 7 is overturned, the “upper surface” or the “lower surface” is represented as, for example, a “left end” or a “right end”.

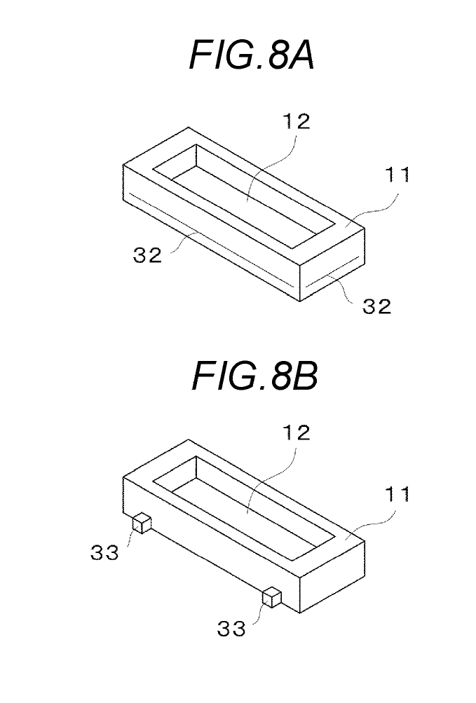

Also, in the embodiment described above, the example in which the positioning member 11 is positioned in a height direction with respect to the rotor core 7 by aligning the lower surface of the positioning member 11 with the same height as the lower surface of the rotor core 7 is shown, but means for positioning the positioning member 11 in the height direction is not limited to this example. For example, as shown in FIG. 8A, it can be also designed to be positioned in the height direction when a positioning mark 32 is drawn on a side surface of the positioning member 11 and the positioning member 11 is inserted into the magnet-insert hole 9 to a depth in which the positioning mark 32 is aligned with the lower surface of the rotor core 7. Alternatively, it can be designed to be positioned in the height direction when a projection 33 is formed on the side surface of the positioning member 11 and the positioning member 11 is inserted into the magnet-insert hole 9 to a depth in which the projection 33 abuts on the lower surface of the rotor core 7.

In the embodiment described above, the case of selecting the epoxy resin as the resin material 13 is illustrated, but the resin material 13 is not limited to the epoxy resin or the thermosetting resin as described above. For example, a thermoplastic resin can be also selected as the resin material 13 as long as a use condition or use in which the temperature of the rotor 3 is not very increased is had.

In the embodiment described above, the example in which the liquid epoxy resin is injected into the resin pool pod 20 is shown, but a process in which a pellet-shaped (solid) epoxy resin is introduced into the resin pool pod 20 and is warmed and liquefied and is pressurized and injected and then the epoxy resin is again warmed and is cured can be also selected depending on the nature of the epoxy resin.

In the embodiment described above, the example in which the upper mold unit 15 is formed with the resin pool pods 20 having the same number as the number of magnet-insert holes 9 of the rotor core 7 is shown, but it may be arranged so as to inject the resin material into the plural magnet-insert holes 9 from the one resin pool pod 20.

Also, the configuration and the form of the electric motor 1 shown in FIG. 1, for example, the shape and the number of teeth 5 of the stator 2, the arrangement, the shape and the number of magnet-insert holes 9 of the rotor 3 are just examples, but not limited thereto.

In addition, in the embodiment described above, the rotor 3 constructing the electric motor 1 is exemplified, but the present invention can be also applied to a rotor used in a generator.

What is claimed is:

1. A method of manufacturing a rotor that includes a permanent magnet inserted into a magnet-insert hole formed in a rotor core, a positioning member which is inserted into the magnet-insert hole and positions the permanent magnet with respect to the rotor core, and a resin material for fixing the permanent magnet to the magnet-insert hole by filling the magnet-insert hole with the resin material, the method comprising:
providing a mold unit above or below the rotor core; and
molding another positioning member used for manufacturing another rotor using the mold unit while filling the magnet-insert hole with the resin material.

2. The method according to claim 1, wherein the rotor core is held between an upper mold unit and a lower mold unit, and
the rotor core is mounted on a resin filling apparatus in which a resin flow path for injecting the resin material into the magnet-insert hole is formed between the rotor core and the upper mold unit or the lower mold unit, and the magnet-insert hole is filled with the resin material.

3. The method according to claim 2, wherein the mold unit is formed in a middle of the resin flow path.

4. The method according to claim 2, wherein the mold unit is formed in a distal part of a branch path branched from the resin flow path.

5. The method according to claim 2, wherein the mold unit is formed in a further distal part of the magnet-insert hole and the resin material is injected into the mold unit through the magnet-insert hole.

6. The method according to claim 2, wherein the rotor core is placed on a jig and is mounted on the resin filling apparatus, and the jig is held between the lower mold unit and the rotor core.

7. The method according to claim 6, wherein a dummy plate abutting on the rotor core above or below the rotor core is mounted on the rotor core, and the rotor core is mounted on the resin filling apparatus.

8. The method according to claim 7, wherein the mold unit includes a recess and a protrusion formed in any of the upper mold unit, the lower mold unit, the dummy plate and the jig, or combination of recesses and protrusions formed in the upper mold unit, the lower mold unit, the dummy plate and the jig.

9. A method of manufacturing a rotor, comprising:
inserting a permanent magnet into a magnet-insert hole formed in a rotor core for the rotor;
inserting a positioning member into the magnet-insert hole to position the permanent magnet with respect to the rotor core;
providing a mold unit above or below the rotor core;
molding another positioning member used for manufacturing another rotor using the mold unit while filling the magnet-insert hole with a resin material; and
curing the resin material to fix the permanent magnet to the magnet-insert hole.
